(19) United States
(12) Patent Application Publication
(10) Pub. No.: US 2026/0119643 A1
(43) Pub. Date: Apr. 30, 2026

(54) Dynamic Adversarial Defense for RF Signal Classification

(71) Applicants: Government of the United States as represented by the Secetary of the Force, Rome, NY (US); Northeastern University, Boston, MA (US)

(72) Inventors: Francesco Restuccia, Boston, MA (US); Milin Zhang, Somerville, MA (US); Jonathan Ashdown, Greenwich, NY (US); Kurt Turck, Lowville, NY (US)

(21) Appl. No.: 19/373,485

(22) Filed: Oct. 29, 2025

Related U.S. Application Data
(60) Provisional application No. 63/713,552, filed on Oct. 29, 2024.

(51) Int. Cl. G06F 21/50; G06N 3/096

(52) U.S. Cl. CPC G06F 21/50; G06N 3/096; G06F 2221/033

(57) ABSTRACT

A method of protecting a neural network from an adversarial attack, comprises generating a first context, generating, by the hypernetwork, a first set of weights based on the first context, and applying the first set of weights to the neural network. The method may further comprise generating a second context subsequent to the first context, generating, by the hypernetwork, a second set of weights based on the second context, and applying the second set of weights to the neural network. The method may further comprise generating additional contexts and corresponding sets of weights, and subsequently applying each of the corresponding sets of weights to the neural network.

### RELATED APPLICATIONS

This application claims the benefit of U.S. Provisional Application No. 63/713,552, filed on Oct. 29, 2024. The entire teachings of the above application are incorporated herein by reference.

### GOVERNMENT SUPPORT

This invention was made with government support under Grant Numbers CNS-2134973, CNS-2312875, ECCS-2229472, ECCS-2329013 awarded by the National Science Foundation, FA8750-21-9-9000 awarded by Air Force Research Laboratory, N00013-23-1-2221 awarded by Office of Naval Research, and FA9550-23-1-0261 awarded by Air Force Office of Scientific Research. The Government has certain rights in the invention.

### BACKGROUND

Deep Neural Networks (DNNs) have achieved significant success in many tactical Radio Frequency Machine Learning Systems (RFMLS) such as signal classification, spectrum sensing, and radio fingerprinting, among others. However, it was demonstrated that adding malicious perturbations to input data can result in a significant performance loss for DNNs. This aspect has been investigated in the literature as Adversarial Machine Learning (AML), which aims at revealing the vulnerabilities of DNNs as well as improving robustness to adversarial perturbations. While a generalized framework of AML in wireless has been investigated, there does not exist a generalized approach to improve adversarial robustness for wireless tasks. On the other hand, current state-of-the-art defense approaches for computer vision tasks cannot meet the needs of RFMLS. For example, although Adversarial Training (AT) leverages malicious inputs to improve robustness during training, it suffers significant performance loss on benign data. Other approaches such as certified robustness and input purification require additional computation cost that can lead to excessive latency for the tactical wireless domain.

### SUMMARY

The described embodiments are directed to a dynamic DNN framework based on hypernetworks, which may be referred to herein as HyperAdv. The HyperAdv framework generates different parameters for the DNN during inference. The changing DNN parameters enhance adversarial robustness by varying gradient direction at each iteration, hence posing a challenge for attackers to find an effective adversarial gradient update. Moreover, an ensemble learning approach is used to diversify DNN parameters.

In one aspect, the invention may be a method of protecting a neural network from an adversarial attack, comprising generating a first context, generating, by the hypernetwork, a first set of weights based on the first context, and applying the first set of weights to the neural network. The method may further comprise generating a second context subsequent to the first context, generating, by the hypernetwork, a second set of weights based on the second context, and applying the second set of weights to the neural network.

The method may further comprise generating additional contexts and corresponding sets of weights, and subsequently applying each of the corresponding sets of weights to the neural network. The method may further comprise mapping the first set of weights to a new space, wherein the new space y′ is given by y′=α⊙y+β, where y represents output logits of the neural network, ⊙ represents element-wise multiplication, α and β are vectors with the same dimension as y, and a set of

$${\{ {α}_{i} \}}_{i = 1}^{n} and {\{ {β}_{i} \}}_{i = 1}^{n}$$

are randomly generated values. The method may further comprise creating an i-th context vector cᵢ={αᵢ,βᵢ} of the new space y′ by concatenating αᵢ and βᵢ. The set of

$${\{ {α}_{i} \}}_{i = 1}^{n} and {\{ {β}_{i} \}}_{i = 1}^{n}$$

may have a uniform distribution U(−1, 1).

The method may further comprise implementing parallel ensemble learning of the neural network by taking all context

$${\{ {c}_{i} \}}_{i = 1}^{n}$$

and generating parameter

$${\{ {W}_{c}^{i} \}}_{i = 1}^{n}$$

for all target models

$${\{ {f}^{i} ( \cdot ) \}}_{i = 1}^{n} ,$$

and utilizing target models

$${\{ {f}^{i} ( \cdot ) \}}_{i = 1}^{n}$$

to generate the first set of weights output

$${\{ {y}^{i} \}}_{i = 1}^{n}$$

for each input context. The method may further comprise providing a loss function for the parallel ensemble learning is

$$ℒ = \frac{1}{n} {\sum }_{i} {ℒ}^{i} ( {f}^{i} ( {W}_{c}^{i} , x ) , {y}^{′ i} )$$

where [symbol] ⁱ(·) denotes the loss function for the i-th target neural network model ƒⁱ(·). The method may further comprise training the hypernetwork by (i) training a teacher hypernetwork using

$$ℒ = \frac{1}{n} {\sum }_{i} {ℒ}^{i} ( {f}^{i} ( {W}_{c}^{i} , x ) , {y}^{′ i} ) ,$$

(ii) training a student hypernetwork by minimizing

$$\frac{1}{n} {\sum }_{i}^{n} {‖ {W}_{c}^{{t}_{i}} - {W}_{c}^{{s}_{i}} ‖}_{2}^{2} where {W}_{c}^{{t}_{i}} and {W}_{c}^{{s}_{i}}$$

are weights of i-th target neural network generated by teacher and student hypernetworks, respectively, and iii) finetune the student hypernetwork using

$$ℒ = \frac{1}{n} {\sum }_{i} {ℒ}^{i} ( {f}^{i} ( {W}_{c}^{i} , x ) , {y}^{′ i} ) .$$

In another aspect, the invention may be a system for resisting an adversarial attack, comprising a hypernetwork that generates two or more sets of values, subsequent in time, based on a corresponding two or more contexts. The system may further comprise a neural network that applies, subsequent in time, the two or more sets of values as neural network weights. The hypernetwork may generate additional contexts and corresponding sets of values, and the neural network applies the additional sets of values as neural network weights. A processor may map the first set of weights to a new space, wherein the new space y′ is given by y′=α⊙y+β where y represents output logits of the neural network, (represents element-wise multiplication, α and β are vectors with the same dimension as y, and a set of

$${\{ {α}_{i} \}}_{i = 1}^{n} and {\{ {β}_{i} \}}_{i = 1}^{n}$$

are randomly generated values. The processor may further create an i-th context vector cᵢ={αᵢ, βᵢ} of the new space y′ by concatenating αᵢ and βᵢ. The set of

$${\{ {α}_{i} \}}_{i = 1}^{n} and {\{ {β}_{i} \}}_{i = 1}^{n}$$

may have a uniform distribution U(−1, 1). The hypernetwork may be trained by parallel ensemble learning of the neural network by taking all context

$${\{ {c}_{i} \}}_{i = 1}^{n}$$

and generating parameters

$${\{ {W}_{c}^{i} \}}_{i = 1}^{n}$$

for all target model

$$1 {\{ {f}^{i} ( \cdot ) \}}_{i = 1}^{n} ,$$

and utilizing target models

$${\{ {f}^{i} ( \cdot ) \}}_{i = 1}^{n}$$

to generate the first set of weights output

$${\{ {y}^{i} \}}_{i = 1}^{n}$$

for each input context.

The hypernetwork may be trained by using a loss function of

$$ℒ = \frac{1}{n} {\sum }_{i} {ℒ}^{i} ( {f}^{i} ( {W}_{c}^{i} , x ) , {y}^{′ i} )$$

where [symbol] ⁱ(·) denotes the loss function for the i-th target neural network model ƒⁱ(·). The hypernetwork may be trained by (i) train a teacher hypernetwork using

$$ℒ = \frac{1}{n} {\sum }_{i} {ℒ}^{i} ( {f}^{i} ( {W}_{c}^{i} , x ) , {y}^{′ i} ) ,$$

(ii) train a student hypernetwork by minimizing

$$\frac{1}{n} {\sum }_{i}^{n} {‖ {W}_{c}^{{t}_{i}} - \text{?} ‖}_{2}^{2} where {W}_{c}^{{t}_{i}} and {W}_{c}^{{s}_{i}}$$

$$\text{?} \text{indicates text missing or illegible when filed}$$

are weights of i-th target neural network generated by teacher and student hypernetworks, respectively, and iii) finetune the student hypernetwork using

$$ℒ = \frac{1}{n} {\sum }_{i} {ℒ}^{i} ( {f}^{i} ( {W}_{c}^{i} , x ) , {y}^{′ i} ) .$$

In yet another aspect, the invention may be a method of protecting a neural network from an adversarial attack, comprising randomly generating a set of context vectors

$${\{ {c}_{i} \}}_{i = 1}^{n} ,$$

generating, by the hypernetwork, n sets of weights based on the set of context vectors

$${\{ {c}_{i} \}}_{i = 1}^{n} ,$$

and applying, in consecutive intervals, each of the n sets of weights to the neural network.

The method may further comprise mapping each of the n sets of weights to a new space, wherein the new space y′ is given by y′=α⊙y+β where y represents output logits of the neural network, ⊙ represents element-wise multiplication, α and β are vectors with the same dimension as y, and a set of

$${\{ {α}_{i} \}}_{i = 1}^{n} and {\{ {β}_{i} \}}_{i = 1}^{n}$$

are randomly generated values. The method may further comprise creating an i-th context vector cᵢ={αᵢ, βᵢ} of the new space y′ by concatenating αᵢ and βᵢ. The set of

$${\{ {α}_{i} \}}_{i = 1}^{n} and {\{ {β}_{i} \}}_{i = 1}^{n}$$

may have a uniform distribution U(−1, 1).

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A shows an adversarial attack on a static DNN classifier.

FIG. 1B shows an adversarial attack on DNN classifier with dynamic weights.

FIG. 2 shows a high-level view of the defense mechanism of the described embodiments.

FIG. 3 shows the classification performance of baseline CNN and this example HyperAdv on clean and PGD-distorted data.

FIG. 4 shows the performance as a function of iterations.

FIG. 5 shows the average of the number of iterations that PGD spends to craft adversarial examples.

FIG. 6 is a diagram of an example internal structure of a processing system that may be used to implement one or more of the embodiments herein.

### DETAILED DESCRIPTION

A description of example embodiments follows.

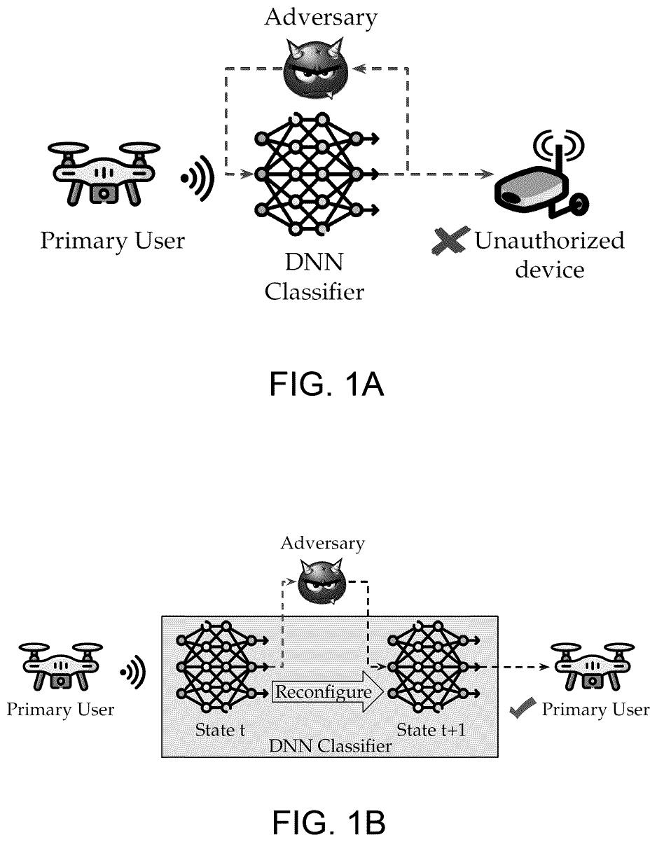

In contrast to the conventional defense mechanisms that train a static robust Deep Neural Network (DNN) classifier or utilize static denoising DNN, the described embodiments are directed to Adversarial Machine Learning (AML) from a dynamic perspective. As depicted in FIG. 1A, a powerful adversarial attack such as Projected Gradient Descent (PGD) can often compromise DNN robustness by iteratively updating the perturbation based on the gradient information of the DNN. To this end, a feasible defense approach to improve DNN robustness can be achieved by dynamically changing the parameters of the DNN. Doing so results in different gradients, so that adversarial updates based on the previous DNN gradient may not be effective for the new DNN model.

The described embodiments are directed to a dynamic DNN framework based on hypernetworks, which may be referred to herein as HyperAdv. The HyperAdv framework generates different parameters for the DNN during inference. The changing DNN parameters enhance adversarial robustness by varying gradient direction at each iteration, hence posing a challenge for attackers to find an effective adversarial gradient update. Moreover, an ensemble learning approach is used to diversify DNN parameters. The described approach first projects the logits of the DNN to a different space via random affine transformations. Then, parallel ensemble learning is used to optimize the projected logit space. To this end, even if ensemble training learned a similar decision boundary for different projected logit spaces, original DNN mappings remain different, hence having a different gradient landscape. The HyperAdv defense approach of the described embodiments is evaluated on the publicly available RadioML 2018.01A dataset. Experimental results demonstrate that this defense approach can improves adversarial accuracy by up to 48%, compared to naturally trained DNN, without compromising clean accuracy. Moreover, the HyperAdv framework can also be integrated with existing static defenses. Compared to adversarial training (AT), he HyperAdv approach improves robustness by over 16% and clean accuracy by approximately 8%.

The described embodiments are directed to a novel dynamic DNN framework that dynamically generates different weights for a target network during inference. Such dynamic design can improve adversarial robustness by changing the gradient update of adversaries without compromising performance.

The described embodiments utilize an ensemble training approach to encourage the hypernetwork to generate diverse model parameters. In addition, we propose a multi-stage training approach to decrease the model complexity of hypernetwork. Our training approach can effectively improve the end-to-end performance as well as reduce the model size of HyperAdv.

We evaluate our defense strategy with publicly available wireless dataset [11], demonstrating 48% improvement in robustness for naturally trained DNN and 16% improvement in robustness as well as 8% improvement in clean accuracy compared to static defensive training.

Adversarial Machine Learning. Without loss of generality, we investigate adversarial evasion attack in multi-class classification problems, such as modulation classification and radio fingerprinting. Formally, the goal of the adversary is to find a minimum perturbation δ such that

$$f ( x + δ ) = {y}^{′} {y}^{′} \neq y \qquad ( 1 )$$

where ƒ(·), x, and y′, y are the DNN classifier, input, DNN output, and groundtruth label, respectively. It has been demonstrated that one-step gradient can be used to generate effective adversarial examples while projected gradient descent (PGD) enhanced the effectiveness by iteratively updating adversarial examples with multiple steps of gradient information, that is

$${x}_{i} + 1 = {x}_{i} + α \cdot \frac{∇ ℒ ( {f}_{W} ( {x}_{t} ) \cdot y )}{{‖ ∇ ℒ ( {f}_{W} ( {x}_{t} ) \cdot y ) ‖}_{p}} \qquad ( 2 )$$

where xₜ denotes the adversarial example at the t-th iteration, W denotes the weights of DNN, and ∇ [symbol] (ƒ_{w}(xₜ), y) denotes the gradient of the cross-entropy loss with respect to DNN output ƒ_{w}(xₜ) and groundtruth y. The term ∥·∥ₚ denotes the Lₚ norm and α is the step size of the adversarial update.

In the black box setting, where the gradient of DNN cannot be accessed, the attacker can train a surrogate model based on outputs of the victim DNN. It was demonstrated that adversarial examples against the surrogate model can be effectively transferred to the original model. To improve robustness to such gradient-based attacks, the DNNs may be trained with adversarial examples, which can be modeled as a min-max optimization problem,

$${min}_{W} 𝔼 \{ {max}_{δ} ℒ ( {f}_{W} ( x + δ ) , y ) \} \qquad ( 3 )$$

where the inner maximization problem denotes adversarial attack and outer minimization problem denotes AT.

While AT significantly enhances DNN robustness, it compromises performance on clean data. TRADES optimizes the trade-off between clean and robust accuracy by incorporating the Kullback-Leibler divergence (KLD) between the clean output and adversarial output into the min-max optimization problem. Equation (3) is refined as

$${min}_{W} 𝔼 \{ ℒ ( {f}_{W} ( x ) , y ) + λ \cdot {max}_{δ} {D}_{KL} ( {f}_{W} ( x ) ‖ {f}_{W} ( x + δ ) ) \} \qquad ( 4 )$$

where D_{KL}(·) denotes the KLD and λ≥0 denotes a trade-off between clean and robust performance.

Adversarial ML in Radio Frequency Machine Learning Systems (RFMLS). AML has been investigated in a RFMLS setting, revealing that well-crafted adversarial examples can lead to a significant loss in performance in RFMLS. For example, exploratory attacks try to train a surrogate model to imitate the functionality of the DNN, while evasion attacks leverage gradient-based methods to craft adversarial inputs. In spoofing attacks, synthetic signals are generated to impersonate a legitimate transmitter. To tackle AML attacks, the model can be trained with adversarial examples or other steps taken to prevent the adversary from building an accurate surrogate model. Existing AML in RFMLS considers only static settings, which is in stark contrast to described embodiments.

A hypernetwork (also referred to herein as a hypernet) is a framework that utilizes a DNN to generate parameters for another DNN. Specifically, the framework consists of a hypernet and a target network. Formally, let H(Ψ, c)=W_{c} denote the hypernet, with learnable parameters Ψ, that generates parameters W_{c} of the target DNN based on a given context c. The target network ƒ(W_{c}, x)=y will take the weight W_{c} and data x as input, and generate an output y. During training, Ψ is end-to-end optimized with context c and output y of the target network. Then, the target network can be dynamically generated at runtime. Hypernetworks have been investigated in many tasks such as continual learning, federated learning, and multi-object optimization. Recently, hypernetworks have been also utilized for robust DNN such as adversarial robustness and out-of-distribution robustness. Input statistics may be considered as context c and the hypernet is used to adapt the input. In contrast, the described embodiments employ randomly generated c, independent of x.

The proposed dynamic defense of the described embodiments is based on a hypernetwork, where a hypernet is used to dynamically generate parameters for another Convolutional Neural Network (CNN) during inference. The overall system consists of a hypernet H(·), a target CNN ƒ(·), and a set of randomly generated context vectors

$${\{ {c}_{i} \}}_{i = 1}^{n} .$$

During training, the hypernet H(Ψ, c) will take n context vectors as input and generate multiple context aware CNN weights

$${\{ {W}_{c}^{i} \}}_{i = 1}^{n} .$$

These parameters are used for the target CNN ƒ(Wc, x) to generate n outputs for each input x. Unlike the conventional end-to-end training aiming at learning the optimal parameters for a single CNN, the described embodiments HyperAdv learns to generate multiple target CNNs with a single hypernet H(·). During inference, the context vector is dynamically changed for each query, thus resulting in a different target CNN for each input. The changing W_{c} generates diverse gradient information at each step, making it more difficult to find effective adversarial samples.

A fundamental question in this dynamic defense framework is how to train a hypernet H(·) so that, for each context c, it can produce a different W_{c} with a unique landscape in hyperspace. As H(·) is end-to-end optimized based on its input c and output y of the target CNN, it may learn an universal solution W_{c}, making all target CNNs output the same y. To diversify W_{c}, the context c may be used in an affine transformation which projects y to a new space y′. Then y′ is treated as the ultimate output of the system in both training and testing. In this case, while calibrated result y′ may be the same due to the end-to-end optimization, the original output y is distinct for different target CNN, making the We unique.

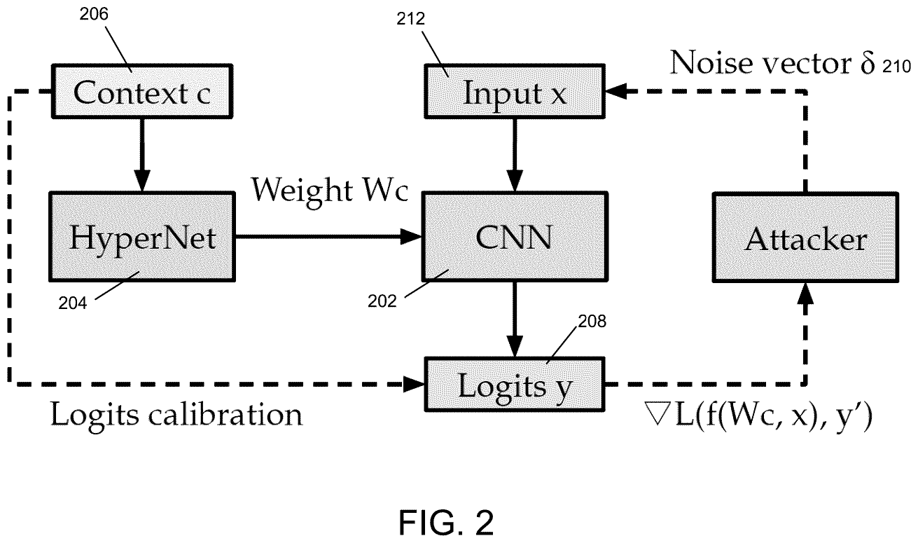

The overall defense mechanism of the described embodiments is depicted in FIG. 2. First, for each input x 212, a context c 206 will be randomly chosen from the predefined context set

$${\{ {c}_{i} \}}_{i = 1}^{n} .$$

Then, the hypernet H(Ψ, c) 204 will generate a set of context-aware parameters W_{c} for the target network. Subsequently, the target CNN 202 ƒ(Wₑ, x)=y will perform inference and generate an output y 208 based on the given Wc. The output y is further calibrated by the context vector and mapped to y′. For each query, HyperAdv will have a different Wc and y′. Thus, the perturbation δ 210 given by the previous gradient ∇ [symbol] (ƒ(W_{c},x), y′) may not be effective for the new target CNN. The following are details of each component in the described embodiments of HyperAdv.

Target Network. A 1-dimensional CNN 202 is utilized, the effectiveness of which has been demonstrated in wireless signal classification tasks. The target CNN 202 consists of six 1-d CNN layers whose kernel size is 1×3 with ReLU activations. Channel sizes of the six CNNs are 64, 64, 128, 128, 256, and 256 respectively. Maxpooling layers are utilized after each CNN layer for down-sampling features. A global average pooling as well as a linear layer are leveraged to decode extracted features and output raw logits y 208. The total number of parameters in the target CNN is about 0.4 million.

Hypernetwork. One challenge in the proposed framework is the complexity of the hypernet 204. To address the resource constraint in many RFMLS scenarios, the size of a hypernet 204 that can generate n target CNNs should be equal to or less than n times of the target CNN's size. However, the small size of hypernet 204 may hamper the end-to-end performance of target CNNs 202. To this end, we initially train a large hypernet (i.e., the teacher) and then train a smaller hypernet (i.e., the student) to learn the output of the teacher. The teacher model consists of 14 independent linear hyper blocks to generate weight and bias of six 1-d CNN layers and 1 linear layer in target CNNs. A hyper block that takes a context vector as input and generates corresponding parameters is defined with 2 linear layers. A rectified linear unit (ReLU) activation is used after the first layer for non-linear transformation. The hidden layer has 256 units, and the output dimension is the size of W_{c}. To reduce the model size, the student model decreases the hidden dimension to 56. In addition, the second linear layer in each hyper block is divided into 8 chunks, with independent linear mappings applied only within each chunk. The ultimate size of Ψ is about 3.1 million.

Context. Training a hypernetwork is intrinsically a model ensemble learning problem. It has been pointed out that naïve ensemble learning can generate a similar decision boundary for different DNN in the hyperspace, making the ensemble vulnerable to transferable adversarial attacks. To increase the diversity of generated DNN, the hypernetwork input context c 206 is also utilized to map the raw output y to a new space y′ that is used for the final inference task. This mapping may be implemented by, for example, a instruction-driven processor or microcontroller, or a hardware state machine. For simplicity, we define such mapping as an affine transformation.

$${y}^{′} = α ⊙ y + β \qquad ( 5 )$$

where ⊙ represents element-wise multiplication, α and β are vectors with the same dimension as y. In practice, a set of

$${\{ {α}_{i} \}}_{i = 1}^{n} and {\{ {β}_{i} \}}_{i = 1}^{n}$$

are randomly generated with a uniform distribution U(−1, 1). Then, the i-th context vector cᵢ={αᵢ, βᵢ} is created by concatenating αᵢ and βᵢ. Experimental results demonstrate that the calibration significantly enhances the diversified ensemble learning.

Learning Strategy. Parallel ensemble learning is leveraged to train HyperAdv. In forward propagation phase, the hypernet will take all context

$${\{ {c}_{i} \}}_{i = 1}^{n}$$

and generate parameters

$${\{ {W}_{c}^{i} \}}_{i = 1}^{n}$$

for all target models

$${\{ {f}^{i} ( \cdot ) \}}_{i = 1}^{n} .$$

### Then,

$${\{ {f}^{i} ( \cdot ) \}}_{i = 1}^{n}$$

are utilized to get output

$${\{ {y}^{i} \}}_{i = 1}^{n}$$

for each input x. The term y′ⁱ is transformed by

$${\{ {c}_{i} \}}_{i = 1}^{n}$$

with Equation (5). The loss of parallel ensemble learning is defined as

$$ℒ = \frac{1}{n} {\sum }_{i} {ℒ}^{i} ( {f}^{i} ( {W}_{c}^{i} , x ) , {y}^{′i} ) \qquad ( 6 )$$

where [symbol] ⁱ(·) denotes the loss function for the i-th target model ƒⁱ(·). In backward propagation phase, the hypernetwork H(Ψ, c) is optimized with gradient descent based on Equation (6). In one example embodiment, n is set to 8. As directly training the small hypernet will compromise the classification performance, a multi-stage training approach is used that comprises i) training a teacher hypernet using Equation (6), ii) training a student hypernet by minimizing

$$\frac{1}{n} {\sum }_{i}^{n} {‖ {W}_{c}^{{t}_{i}} - {W}_{c}^{{s}_{i}} ‖}_{2}^{2} , where {W}_{c}^{{t}_{i}} and {W}_{c}^{{s}_{i}}$$

are weights of i-th target CNN generated by teacher and student hypernets, respectively; and iii) finetune the student hypernet using Equation (6).

Example Embodiment Setup of HyperAdv. The defense is evaluated based on a multi-class modulation classification task. The RadioML 2018.01A dataset is employed, which consists of 24 different modulation classes with Signal to Noise Ratio (SNR) range from −20 dB to 30 dB. Only signals with SNR greater than 10 dB are trained. The utilized dataset consists of 1.08 million signals, each comprising 1024 in-phase and quadrature (I/Q) samples. The dataset is split into training and testing set with a ratio of 0.8 to 0.2. To compare the improvement of HyperAdv, we train a CNN which has the same architecture as the target network. As HyperAdv can be incorporated with other static defense approaches, HyperAdv and the baseline CNN are also trained with two defensive training methods. Models trained with conventional cross-entropy loss are denoted as “Natural Training (NT)” while models trained with conventional adversarial training and adversarial training that optimizes regularized surrogate loss are denoted as AT and TRADES, respectively. Models are trained on all training data with a mixed SNR range using the Adam optimizer. Baseline CNNs and teacher hypernetworks are trained for 50 epochs with a learning rate of 0.0001. Student hypernets are initially trained to regress the weights W_{c} generated by the teachers using a learning rate of 0.001, and then fine-tuned for 1 epoch with a learning rate of 0.0001.

We consider loc PGD attack with a perturbation δ≤0.05 in the white-box setting where the attacker can access the weights W_{c} of target CNN at each step. Note that this attack model is more severe than a generalized wireless AML setting, as path loss and fading are not added to perturbations. The attacker has complete gradient information of the target CNN as well as a perfect wireless propagation channel. Thus, the results of this example present a worst-case scenario of robustness. In real world applications, HyperAdv can provide better robustness as attackers have limited knowledge of the victim model, and face non-ideal wireless channel conditions.

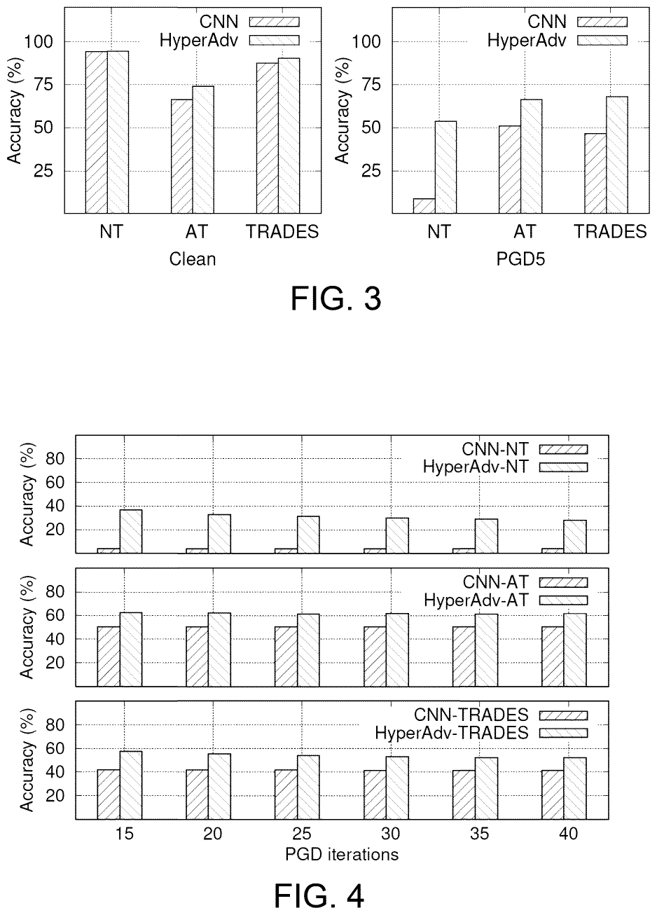

Robustness Trade-off FIG. 3 shows the classification performance of baseline CNN and this example HyperAdv on clean and PGD-distorted data, where the number of PGD iterations is set to 5. FIG. 3 depicts the trade-off between clean and adversarial accuracy. The left-most graph of FIG. 3 shows the baseline CNN and HyperAdv performance on clean data with different training approaches. The right-most graph of FIG. 3 show baseline CNN and HyperAdv performance on PGD-distorted data with different training approaches. FIG. 4 shows the performance as a function of iterations. FIG. 4 shows robust accuracy as a function of PGD iterations. The top-most graph of FIG. 4 shows a naturally trained CNN and HyperAdv. The middle graph of FIG. 4 shows an adversarially trained CNN and HyperAdv. The bottom-most graph of FIG. 4 shows CNN and HyperAdv trained with TRADES algorithm. The naturally trained CNN achieves 94.20% accuracy on clean data and 8.54% accuracy on adversarial data. Although AT and TRADES improve the adversarial accuracy to 50.88% and 46.62% respectively, the clean accuracy is reduced to 66.28% and 87.55% respectively. This is because AT and TRADES trained with only adversarial data may suffer adversarial overfitting. While they increase classification performance on adversarial examples, there is considerable loss of accuracy on benign data. To this end, such static defense approaches are not suitable for reliable RFMLS. On the other hand, HyperAdv achieves 56.30% accuracy on PGD attack, 47.76% improvement compared to CNN-NT. The performance on benign data is 95.20%, which is comparable to CNN-NT. Thus, HyperAdv improves adversarial robustness without sacrificing clean accuracy.

In addition, HyperAdv can be applied to other defense to further enhance robustness. By incorporating HyperAdv with AT and TRADES, the adversarial robustness increases by 15.52% and 22.00%, respectively. Interestingly, HyperAdv also improves the AT and TRADES performance on clean data by 7.73% and 2.82%. This is because ensemble learning intrinsically augments the adversarial samples with different models during training, thereby mitigating the overfitting of adversarial data and improving performance.

Effect of Dynamic Inference. To comprehensively evaluate the enhanced robustness introduced by the dynamic design of HyperAdv, we also perform PGD attack on its static counterparts. First, use of a single context consistently during inference is considered, denoting this model as HyperAdv-S. In this case, the attacker consistently updates adversarial examples against a single set of weights. Thus, HyperAdv-S represents the static robust performance for single target model. In addition, use of the ensemble of all target models for inference is considered, without dynamically changing the model parameters. The inference output is the average of projected output y′ of all target CNNs. In this case, the adversarial gradient information can be backpropagated through all target models. This scenario, denoted as HyperAdv-E, describes the static robustness of overall target models. The original HyperAdv with randomly changed context is denoted as HyperAdv-R.

TABLE I
Accuracy of HyperAdv and its static counterparts

| | NT | | AT | | TRADES | |
|---|---|---|---|---|---|---|
| | Clean | PGD | Clean | PGD | Clean | PGD |
| CNN | 94.20 | 3.72 | 66.28 | 50.42 | 87.55 | 43.16 |
| HyperAdv-R | 95.20 | 45.02 | 74.01 | 63.98 | 90.37 | 60.92 |
| HyperAdv-S | 95.11 | 23.70 | 72.74 | 50.10 | 91.27 | 43.08 |
| HyperAdv-E | 96.34 | 27.88 | 78.36 | 61.34 | 92.79 | 49.50 |

Table I shows performance of HyperAdv-R and its static counterparts on both clean and adversarial data. The naive CNN without hypernetworks is also reported as a baseline. The number of PGD iterations are increased to 10 for more comprehensive assessments. HyperAdv-E achieves slightly better performance on clean data compared to others due to the effect of ensemble inference. HyperAdv-E also has better performance on adversarial data compared to HyperAdv-S and baseline CNN due to the same reason. Compared to CNNNT, HyperAdv-S can improve the robust accuracy by roughly 20%, which indicates that the diversified ensemble learning can improve adversarial robustness to some extent [32]. However, for AT and TRADES, HyperAdv-S exhibits no difference in performance on adversarial examples in comparison to CNN, meaning that the ensemble learning without dynamics on adversarial examples is less effective when combined with powerful defense such as AT and TRADES. On the other hand, HyperAdv-R achieves best accuracy on adversarial data compared to other two static HyperAdv, indicating that the dynamic inference mechanism can effectively mitigate the iterative gradient search of adversarial attacks.

Robustness as a Function of Iterations. FIG. 4 illustrates robustness of HyperAdv as a function of PGD iterations. For NT, the adversarial robustness decreases from 36.62% to 27.74% with an increase in the number of iterations. This indicates that HyperAdv requires more computation resources for attackers to find effective gradient information. Moreover, the worst-case robustness (with maximum PGD iterations) of HyperAdv is 23.82% higher than that of the basic CNN, indicating that the robustness is barely degraded by increasing computation. This is because multiple target CNNs have diverse parameters which results in distinct gradient landscape. Attacks searching the gradient across multiple target CNNs will result in a sharp overlapping landscape, trapping gradient descent at an ineffective local minimum. This observation is further supported by the results of AT and TRADES in FIG. 4. For AT and TRADES, HyperAdv constantly outperforms basic CNN by 11.08% and 12.28% on average, which means the sharpness of the overall gradient landscape significantly increases the robustness.

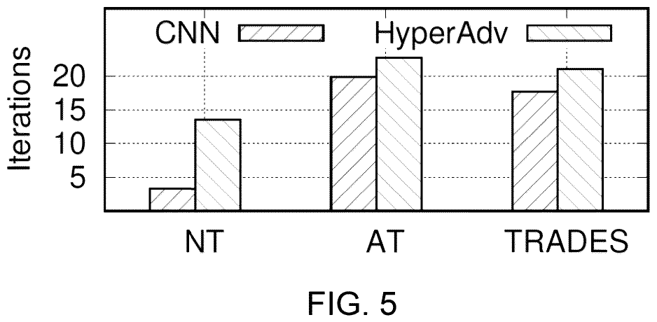

Computational cost of PGD Attack. Latency is often a critical need of many RFMLS systems. Therefore, an effective adversarial attack with large number of iterations may not be realistic for AML in RFMLS. To this end, we also assess our defense strategy with the computational cost of PGD. FIG. 5 shows the average of the number of iterations that PGD spends to craft adversarial examples (the maximum number of iterations is considered as 40). The average number of PGD iterations against CNN-NT, -AT and -TRADES are 3.31, 19.83 and 17.64, respectively. Compared to baseline CNN, HyperAdv increases the average number of iterations to 13.53, 22.66 and 21.01 for NT, AT and TRADES respectively. This improvement is due to the dynamic nature of HyperAdv which can generate diverse gradients against the adversary. With an increasing number of iterations, the effective perturbation may not be found within the time limit, hence resulting in a computationally robust system.

The described embodiments implement a novel defense for AML in RFMLS that dynamically alters DNN parameters during inference, making it challenging for adversaries to obtain effective gradient information for attacks. Example embodiments demonstrate that this dynamic defense enhances the adversarial robustness of naturally trained DNNs by 48% without compromising performance on clean data. Furthermore, the approach of the described embodiments can be combined with other static defenses to further improve performance. Integrating the approach of the described embodiments with static adversarial training increases adversarial robustness by 16% and improves performance on benign data by 8%.

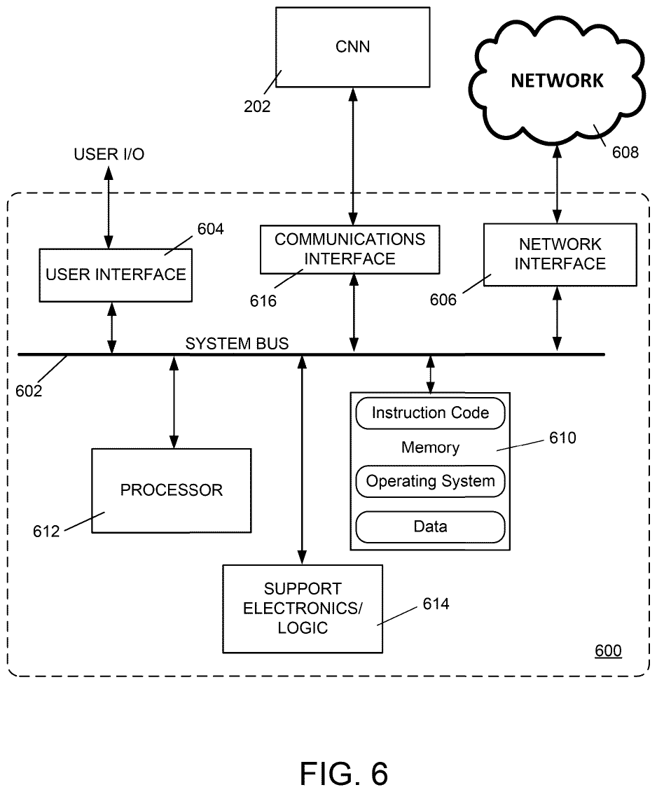

FIG. 6 is a diagram of an example internal structure of a processing system 600 that may be used to implement one or more of the embodiments herein. Each processing system 600 contains a system bus 602, where a bus is a set of hardware lines used for data transfer among the components of a computer or processing system. The system bus 602 is essentially a shared conduit that connects different components of a processing system (e.g., processor, disk storage, memory, input/output ports, network ports, etc.) that enables the transfer of information between the components.

Attached to the system bus 602 is a user I/O device interface 604 for connecting various input and output devices (e.g., keyboard, mouse, displays, printers, speakers, etc.) to the processing system 600. A network interface 606 allows the computer to connect to various other devices attached to a network 608. Memory 610 provides volatile and non-volatile storage for information such as computer software instructions used to implement one or more of the embodiments of the present invention described herein, for data generated internally and for data received from sources external to the processing system 600.

A central processor unit 612 is also attached to the system bus X02 and provides for the execution of computer instructions stored in memory 610. The system may also include support electronics/logic 614, and a communications interface 616. In one example embodiment, the communications interface may communicate with the neural network 202 to implement, for example, the mapping from y to y′ as described herein.

In one embodiment, the information stored in memory 610 may comprise a computer program product, such that the memory 610 may comprise a non-transitory computer-readable medium (e.g., a removable storage medium such as one or more DVD-ROM's, CD-ROM's, diskettes, tapes, etc.) that provides at least a portion of the software instructions for the invention system. The computer program product can be installed by any suitable software installation procedure, as is well known in the art. In another embodiment, at least a portion of the software instructions may also be downloaded over a cable communication and/or wireless connection.

It will be apparent that one or more embodiments described herein may be implemented in many different forms of software and hardware. Software code and/or specialized hardware used to implement embodiments described herein is not limiting of the embodiments of the invention described herein. Thus, the operation and behavior of embodiments are described without reference to specific software code and/or specialized hardware—it being understood that one would be able to design software and/or hardware to implement the embodiments based on the description herein.

Further, certain embodiments of the example embodiments described herein may be implemented as logic that performs one or more functions. This logic may be hardware-based, software-based, or a combination of hardware-based and software-based. Some or all of the logic may be stored on one or more tangible, non-transitory, computer-readable storage media and may include computer-executable instructions that may be executed by a controller or processor. The computer-executable instructions may include instructions that implement one or more embodiments of the invention. The tangible, non-transitory, computer-readable storage media may be volatile or non-volatile and may include, for example, flash memories, dynamic memories, removable disks, and non-removable disks.

While example embodiments have been particularly shown and described, it will be understood by those skilled in the art that various changes in form and details may be made therein without departing from the scope of the embodiments encompassed by the appended claims.

What is claimed is:

1. A method of protecting a neural network from an adversarial attack, comprising;
generating a first context;
generating, by the hypernetwork, a first set of weights based on the first context;
applying the first set of weights to the neural network;
generating a second context subsequent to the first context;
generating, by the hypernetwork, a second set of weights based on the second context; and
applying the second set of weights to the neural network.

2. The method of claim 1, further comprising generating additional contexts and corresponding sets of weights, and subsequently applying each of the corresponding sets of weights to the neural network.

3. The method of claim 1, further comprising mapping the first set of weights to a new space, wherein the new space y′ is given by
$${y}^{′} = α ⊙ y + β$$
where y represents output logits of the neural network, ⊙ represents element-wise multiplication, α and β are vectors with the same dimension as y, and a set of
$${\{ {α}_{i} \}}_{i = 1}^{n} and {\{ {β}_{i} \}}_{i = 1}^{n}$$
are randomly generated values.

4. The method of claim 3, further comprising creating an i-th context vector cᵢ={αᵢ, βᵢ} of the new space y′ by concatenating αᵢ and βᵢ.

5. The method of claim 3, wherein the set of
$${\{ {α}_{i} \}}_{i = 1}^{n} and {\{ {β}_{i} \}}_{i = 1}^{n}$$
have a uniform distribution U(−1, 1).

6. The method of claim 1, further comprising implementing parallel ensemble learning of the neural network by taking all context
$${\{ {c}_{i} \}}_{i = 1}^{n}$$
and generating parameters
$${\{ {W}_{c}^{i} \}}_{i = 1}^{n}$$
for all target models
$${\{ {f}^{i} ( \cdot ) \}}_{i = 1}^{n} ,$$
and utilizing target models
$${\{ {f}^{i} ( \cdot ) \}}_{i = 1}^{n}$$
to generate the first set of weights output
$${\{ {y}^{i} \}}_{i = 1}^{n}$$
for each input context.

7. The method of claim 6, further comprising providing a loss function for the parallel ensemble learning is
$$ℒ = \frac{1}{n} {\sum }_{i} {ℒ}^{i} ( {f}^{i} ( {W}_{c}^{i} , x ) , {y}^{′ i} )$$
where [symbol] ⁱ(·) denotes the loss function for the i-th target neural network model ƒⁱ(·).

8. The method of claim 1, further comprising training the hypernetwork by (i) training a teacher hypernetwork using
$$ℒ = \frac{1}{n} {\sum }_{i} {ℒ}^{i} ( {f}^{i} ( {W}_{c}^{i} , x ) , {y}^{′ i} ) ,$$
(ii) training a student hypernetwork by minimizing
$$\frac{1}{n} {\sum }_{i}^{n} {‖ {W}_{c}^{{t}_{i}} - {W}_{c}^{{s}_{i}} ‖}_{2}^{2} where {W}_{c}^{{t}_{i}} and {W}_{c}^{{s}_{i}}$$
are weights of i-th target neural network generated by teacher and student hypernetworks, respectively; and iii) finetune the student hypernetwork using
$$ℒ = \frac{1}{n} {\sum }_{i} {ℒ}^{i} ( {f}^{i} ( {W}_{c}^{i} , x ) , {y}^{′ i} ) .$$

9. A system for resisting an adversarial attack, comprising:
a hypernetwork that generates two or more sets of values, subsequent in time, based on a corresponding two or more contexts; and
a neural network that applies, subsequent in time, the two or more sets of values as neural network weights.

10. The system of claim 9, wherein the hypernetwork generates additional contexts and corresponding sets of values, and the neural network applies the additional sets of values as neural network weights.

11. The system of claim 9, wherein a processor maps the first set of weights to a new space, wherein the new space y′ is given by
$${y}^{′} = α ⊙ y + β$$
where y represents output logits of the neural network, ⊙ represents element-wise multiplication, α and β are vectors with the same dimension as y, and a set of
$${\{ {α}_{i} \}}_{i = 1}^{n} and {\{ {β}_{i} \}}_{i = 1}^{n}$$
are randomly generated values.

12. The system of claim 11, wherein the processor further creates an i-th context vector cᵢ={αᵢ, βᵢ} of the new space y′ by concatenating αᵢ and βᵢ.

13. The system of claim 11, wherein the set of
$${\{ {α}_{i} \}}_{i = 1}^{n} and {\{ {β}_{i} \}}_{i = 1}^{n}$$
have a uniform distribution U(−1, 1).

14. The system of claim 9, wherein the hypernetwork is trained by parallel ensemble learning of the neural network by taking all context
$${\{ {c}_{i} \}}_{i = 1}^{n}$$
and generating parameters
$${\{ {W}_{c}^{i} \}}_{i = 1}^{n}$$
for all target models
$${\{ {f}^{i} ( \cdot ) \}}_{i = 1}^{n} ,$$
and utilizing target models
$${\{ {f}^{i} ( \cdot ) \}}_{i = 1}^{n}$$
to generate the first set of weights output
$${\{ {y}^{i} \}}_{i = 1}^{n}$$
for each input context.

15. The system of claim 9, wherein the hypernetwork is trained by using a loss function of
$$ℒ = \frac{1}{n} {\sum }_{i} {ℒ}^{i} ( {f}^{i} ( {W}_{c}^{i} , x ) , {y}^{′ i} )$$
where [symbol] ⁱ(·) denotes the loss function for the i-th target neural network model ƒⁱ(·).

16. The system of claim 9, wherein the hypernetwork is trained by (i) train a teacher hypernetwork using
$$ℒ = \frac{1}{n} {\sum }_{i} {ℒ}^{i} ( {f}^{i} ( {W}_{c}^{i} , x ) , {y}^{′ i} ) ,$$
(ii) train a student hypernetwork by minimizing
$$\frac{1}{n} {\sum }_{i}^{n} {‖ {W}_{c}^{{t}_{i}} - {W}_{c}^{{s}_{i}} ‖}_{2}^{2} where {W}_{c}^{{t}_{i}} and {W}_{c}^{{s}_{i}}$$
are weights of i-th target neural network generated by teacher and student hypernetworks, respectively; and iii) finetune the student hypernetwork using
$$ℒ = \frac{1}{n} {\sum }_{i} {ℒ}^{i} ( {f}^{i} ( {W}_{c}^{i} , x ) , {y}^{′ i} ) .$$

17. A method of protecting a neural network from an adversarial attack, comprising;
randomly generating a set of context vectors
$${\{ {c}_{i} \}}_{i = 1}^{n} ;$$
generating, by the hypernetwork, n sets of weights based on the set of context vectors
$${\{ {c}_{i} \}}_{i = 1}^{n} ;$$
and
applying, in consecutive intervals, each of the n sets of weights to the neural network.

18. The method of claim 17, further comprising mapping each of the n sets of weights to a new space, wherein the new space y′ is given by
$${y}^{′} = α ⊙ y + β$$
where y represents output logits of the neural network, ⊙ represents element-wise multiplication, α and β are vectors with the same dimension as y, and a set of
$${\{ {α}_{i} \}}_{i = 1}^{n} and {\{ {β}_{i} \}}_{i = 1}^{n}$$
are randomly generated values.

19. The method of claim 18, further comprising creating an i-th context vector cᵢ={αᵢ, βᵢ} of the new space y′ by concatenating αᵢ and βᵢ.

20. The method of claim 18, wherein the set of
$${\{ {α}_{i} \}}_{i = 1}^{n} and {\{ {β}_{i} \}}_{i = 1}^{n}$$
have a uniform distribution U(−1, 1).
